(19) United States
(12) Patent Application Publication
(10) Pub. No.: US 2006/0057597 A1
(43) Pub. Date: Mar. 16, 2006

(54) Method and system for processing nanoparticles using a self assembly mechanism to form combined species

(75) Inventors: Yu-Chong Tai, Pasadena, CA (US); Chi-Yuan Shih, Pasadena, CA (US); Siyang Zheng, Pasadena, CA (US)

Correspondence Address: FOLEY AND LARDNER LLP;SUITE 500, 3000 K STREET NW, WASHINGTON, DC, 20007, US

(73) Assignee: California Institute of Technology, Pasadena, CA (US)

(21) Appl. No.: 10/985,841

(22) Filed: Nov. 9, 2004

Related U.S. Application Data
(60) Provisional application No. 60/519,158, filed on Nov. 12, 2003.

(51) Int. Cl. C40B 40/08; C40B 40/10

(52) U.S. Cl. 435/6; 435/7.1

(57) ABSTRACT

A method for processing nanoparticles using a self assembly mechanism. The method includes flowing a first reactant species through a first channel region, which has a predetermined dimension including a first width and a first depth. The method includes flowing a second reactant species through a second channel region, which also has a predetermined dimension including a second width and a second depth. The method includes outputting the first reactant species through a first orifice exiting the first channel region and outputting the second reactant species through a second orifice exiting the second channel region. Additionally, the method forms an interface region along a first predetermined length in a third channel, which couples the first orifice to the second orifice at the interface region. The method contacts one or more of the first reactant species with one or more of the second reactant species at the interface region to form a combined species of the one or more first reactant species and the one or more second reactant species. The method also transfers the combined species of the one or more first reactant and the one or more second reactant species from the first predetermined length to a second predetermined length of the third channel region.

### CROSS-REFERENCES TO RELATED APPLICATIONS

This application claims priority to U.S. Provisional No. 60/519,158, filed Nov. 12, 2003, incorporated by reference herein for all purposes.

### STATEMENT AS TO RIGHTS TO INVENTIONS MADE UNDER FEDERALLY SPONSORED RESEARCH OR DEVELOPMENT

Work described herein has been supported, in part, by DARPA Biomolecular Motor Program (Grant No. ______). The United States Government may therefore have certain rights in the invention.

### BACKGROUND OF THE INVENTION

The present invention relates generally to manufacturing objects. More particularly, the invention provides a method and system for manufacturing a combined species of nanoparticles using a self assembly technique. Merely by way of example, the invention has been applied to the manufacture of a nanostructure using a fluidic chip structure. But it would be recognized that the invention has a much broader range of applicability. For example, the invention can be applied to high pressure liquid chromatography (HPLC) column stationary phase packing with nanoparticles, chemiresistor fabricated with nanoparticle film, artificial muscle synthesis, and others.

Human beings have been building larger and more complex things with smaller components using assembly techniques. As an example, Germany's Karl Benz has been recognized with a three wheeled automobile he produced in 1886 as one of the first. Such automobile included an engine that was placed over its rear axle, which was made using an assembling process. The engine, which was also manually assembled. was a horizontal, four-cycle, single-cylinder type. Horsepower, which was limited came from an engine that produced about 1 horsepower. Belts and chains harnessed such power to rear wheels, yielding a top speed of about 15 km/h. Assembly of mechanical technologies such as a lever connected to a rack-and-pinion controlled a single front wheel to steer the automobile. In the early 1900's, Ford produced a very popular automobile called “The Model T.” The Model T had technologies that spread motorization. Such technologies included various mechanisms for easy driving. Examples of such mechanisms included a planetary gear transmission. Most particularly, the Model T was produced in mass production, which provided a low price to allow many people to purchase and enjoy the Model T. More than 15,000,000 units were built from 1908 to 1927, which revolutionized the automotive industry. The mass production of automobiles used large scale assembly techniques.

Other types of manufacturing techniques have also developed. The manufacture of microelectronics is another example of a manufacturing technique that has proliferated into many aspects of modern day life. In the early days, Robert N. Noyce invented the integrated circuit, which is described in “Semiconductor Device-and-Lead Structure” under U.S. Pat. No. 2,981,877. Integrated circuits evolved from a handful of electronic elements into millions and even billions of components fabricated on a small slice of silicon material. Such integrated circuits have been incorporated into and control many conventional devices, such as automobiles, computers, medical equipment, and even children's toys. Integrated circuits have been manufactured using what is known as a “planar process.”

More recently, nano-materials have attracted a research interest for a variety of applications. More particularly, nano-materials have been used for sensing devices. For example, nanoparticle-molecule composite film can change its electrical conductivity with high sensitivity and selectivity upon absorbing different organic vapors. [See, H. Wohltjen, A. W. Snow, Anal. Chem., 70, p. 2856, (1998)] However, conventional nanoparticle films are in general prepared via layer-by-layer deposition methods, where nanoparticle and molecule layers are deposited alternatively until reaching the desired film thickness. [See, T. Vossmeyer, B. Guse, I. Besnard, R. E. Bauer, K. Mullen, A. Yasuda, Adv. Mater., 14, No. 3, p. 238, (2002)] There are two major drawbacks in this approach. First, layer-by-layer deposition is simply too laborious and time-consuming. Second, in order to form dense SAM monolayer, it is often necessary to have rigorous substrate cleaning [See, H. Wohltjen, A. W. Snow, Anal. Chem., 70, p. 2856, (1998); See also, T. Vossmeyer, B. Guse, I. Besnard, R. E. Bauer, K. Mullen, A. Yasuda, Adv. Mater., 14, No. 3, p. 238, (2002)], which may damage the embedded CMOS or other devices on the sensor chip. These and other shortcomings of the conventional techniques can be found throughout the present specification and more particularly below.

From the above, it is seen that techniques for manufacturing improved objects are highly desirable.

### BRIEF SUMMARY OF THE INVENTION

According to the present invention, techniques for manufacturing objects are provided. More particularly, the invention provides a method and system for manufacturing a combined species of nanoparticles using a self assembly technique. Merely by way of example, the invention has been applied to the manufacture of a nanostructure using a fluidic chip structure. But it would be recognized that the invention has a much broader range of applicability. For example, the invention can be applied to high pressure liquid chromatography (HPLC) column stationary phase packing with nanoparticles, chemiresistor fabricated with nanoparticle film, artificial muscle synthesis, and others.

As will be illustrated, precision molecular assembly is the cornerstone of nanotechnology according to a preferred embodiment. It follows that the major technical challenge is to assemble arrays of motor-molecules repeatedly and coherently from the nano up to the micro scale. In this kind of assembly, it's desirable to be able to control the location of the assembly, the size of the self-assembled aggregate and the microstructure of the aggregate. To achieve these goals, we have designed microfluidic systems and methods, which have shear-flow channels to bring initial materials, electrodes that can generate electric field for enhanced assembly and in-channel collectors for aggregate collection and shape definition. We demonstrate the feasibility of the proposed technique with multiple examples of molecular assembly according to specific embodiments of the present invention.

In a specific embodiment, the present invention provides a method for processing nanoparticles using a self assembly mechanism. The method includes flowing a first reactant species through a first channel region, which has a predetermined dimension including a first width and a first depth. The method includes flowing a second reactant species through a second channel region, which also has a predetermined dimension including a second width and a second depth. The method includes outputting the first reactant species through a first orifice exiting the first channel region and outputting the second reactant species through a second orifice exiting the second channel region. Additionally, the method forms an interface region along a first predetermined length in a third channel, which couples the first orifice to the second orifice at the interface region. The method contacts one or more of the first reactant species with one or more of the second reactant species at the interface region to form a combined species of the one or more first reactant species and the one or more second reactant species. The method also transfers the combined species of the one or more first reactant and the one or more second reactant species from the first predetermined length to a second predetermined length of the third channel region.

In an alternative specific embodiment, the present invention provides a system for processing nanoparticles using a self assembly mechanism. The system has a substrate and a first channel region disposed on a first portion of the substrate. The first channel region has a predetermined dimension including a first width and a first depth. The first channel region is configured to allow a first reactant species to flow there through. A second channel region is disposed on the second portion of substrate. The second channel region has a predetermined dimension including a second width and a second depth. The second channel region is configured to allow a second reactant species to flow there through. A first orifice is coupled to an end of the first channel region, which is configured to output the first reactant species. A second orifice is coupled to an end of the second channel region, which is configured to output the second reactant species. A third channel region is disposed on a third portion of the substrate. The third channel region has a first predetermined length and a second predetermined length. The system has an interface region along the first predetermined length in the third channel region, which is coupling the first orifice and to the second orifice at the interface region. One or more of the first reactant species is contacted with one or more of the second reactant species at the interface region to form a combined species of the one or more first reactant species and the one or more second reactant species. The combined species of the one or more first reactant and the one or more second reactant species is transferred from the first predetermined length to the second predetermined length of the third channel region.

Still further, the present invention provides a method for fabricating a self-assembly device. The method includes providing a first substrate, which has a surface region. The first substrate is made of a material such as silicon, glass, or others. The method includes forming a first channel region, a second channel region, and a third channel region, including an interface region, in the first substrate. The forming process often uses photolithographic and etching techniques according to a specific embodiment. The method includes depositing a polymer layer overlying the surface region of the substrate to imprint the first channel region, the second channel region, and the third channel region thereon. According to a specific embodiment, the polymer layer (or layers) can be any suitable material such as PDMS, Parylene, PMMA, and soda lime glass. The method includes coupling the polymer layer including the imprint of the first channel region, the second channel region, and the third channel region onto a second substrate. The coupling process often includes aligning the first and second substrates together and then bonding them together according to a specific embodiment. The method provides the coupled polymer layer including the imprint of the first channel region, the second channel region, and the third channel region with the second substrate and uses the coupled polymer layer and second substrate for a self-assembly or other like process, which has been described throughout the present specification and more particularly below.

Numerous benefits are achieved using the present invention over conventional techniques, depending upon the embodiment. The present invention provides an improved method and system for self-assembly of reactant species according to a specific embodiment. other benefits that may be included in one or more embodiments are as follows:

1. Improved efficiency of assembly according to certain embodiments.

Molecular assembly inside the proposed microfluidic device greatly improves the assembly efficiency compared with simple mixing of reactants for spontaneous assembly in test tube. The aggregate grows continuously because flows from channel one and channel two continue to supply fresh nano-materials to the interface leading to large aggregates.

2. Selective growth of self-assembled material in other embodiments.

With the techniques developed by us, assembly process only happens or selectively happens at the interface of flows of reactant and they are further confined by inertial shear flows and can be concentrated on electrode surface using electric field.

3. In-channel electrodes can serve multiple purposes according to certain embodiments.

First, as demonstrated in the example, they can greatly enhance assembly efficiency. Second, the in-situ integration of assembled material on electrodes is an efficient and cost-saving way for molecular electronics device fabrication. Third, electrodes can serve as sensors to monitor assembly process through conductivity measurement.

4. In-channel collector is a novel design to accumulate self-assembled product according to a specific embodiment.

Depending upon the embodiment, one or more of these benefits may be achieved. These and other benefits are provided throughout the present specification and more particularly below.

Various additional objects, features and advantages of the present invention can be more fully appreciated with reference to the detailed description and accompanying drawings that follow.

### BRIEF DESCRIPTION OF THE DRAWINGS

FIG. 1 is a simplified diagram of a self-assembly device according to an embodiment of the present invention;

FIG. 2 is a more detailed diagram of an interface region for the self-assembly device according to an embodiment of the present invention;

FIG. 3 is a simplified block diagram of a self-assembly system according to an embodiment of the present invention;

FIG. 4 is a simplified diagram of a process flow for fabricating a self-assembly system according to an embodiment of the present invention;

FIG. 5 illustrates various simplified diagrams for muscle molecule and gold nanoparticle assembly according to a specific embodiment;

FIG. 6 illustrates gold nanoparticle assembly assisted by DNA hybridization according to a specific embodiment; and

FIG. 7 illustrates sheet/fiber structure formed by self assembly according to a specific embodiment.

### DETAILED DESCRIPTION OF THE INVENTION

According to the present invention, techniques for manufacturing objects are provided. More particularly, the invention provides a method and system for manufacturing a combined species of nanoparticles using a self assembly technique. Merely by way of example, the invention has been applied to the manufacture of a nanostructure using a fluidic chip structure. But it would be recognized that the invention has a much broader range of applicability. For example, the invention can be applied to high pressure liquid chromatography (HPLC) column stationary phase packing with nanoparticles, chemiresistor fabricated with nanoparticle film, artificial muscle synthesis, and others.

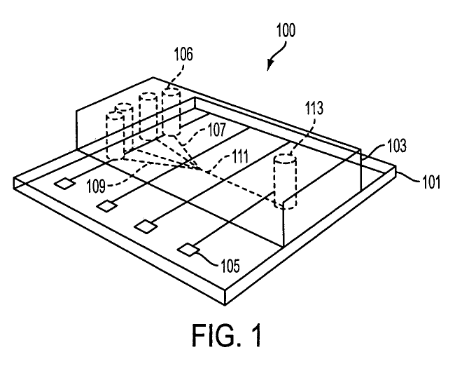

FIG. 1 is a simplified diagram of a self-assembly device according to an embodiment of the present invention. This diagram is merely an example, which should not unduly limit the scope of the claims herein. One of ordinary skill in the art would recognize many variations, modifications, and alternatives. As shown, the self assembly device 100 includes a substrate 101, which includes various channels therein 107, 109, 111. An overlying thickness of material 103 is also overlying the substrate. The overlying thickness of material includes input chambers 106 and output chamber(s) 113. The substrate also has input pads for provided a voltage potential on various regions of the substrate and liquid channel regions.

In one embodiment, the self assembly device 100 is an enhanced 3D self-assembly shear flow device. In another embodiment, the self assembly device 100 demonstrates the proposed microfluidic device for enhanced 3D self-assembly. Suppose the assembly desires mixing of two reactants, including a first reactant species and a second reactant species. The two input channels are feed in fresh materials. Right after mixing, the central flow is focused and shaped by two shear flows with proper inertial fluid. For example, the mixing occurs only around the flow interface, and the central flow represents the flow region where the interface reaction or mixing occurs. Thin layer metal electrodes are placed inside fluid channels at downstream. During the assembly, electric field is applied between the electrodes. The electric field as generated can enhance the assembly efficiency and also it provides selective-growth of the assembled material on electrodes. Collectors are designed inside the fluidic channels in a downstream location 113. These collectors have discontinuous sidewalls to work as sifts so that fluid can pass and large size aggregate can be trapped and link into bigger size with a preferred geometry. Collectors with various size and geometry can be put anywhere inside the channel. According to a preferred embodiment, the present device and method accumulates and grows large self-assembled aggregate with a preferred geometry.

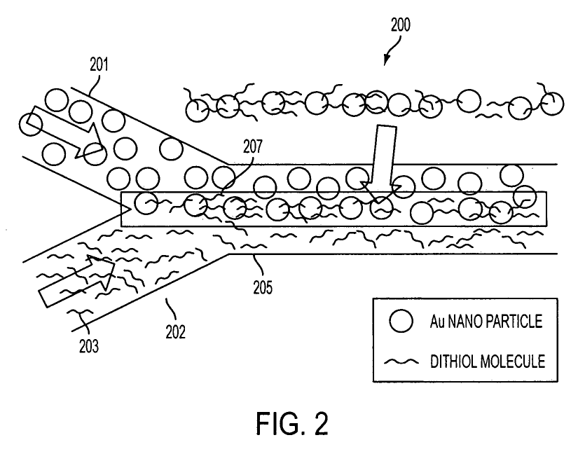

Referring now to FIG. 2, the present invention provides a system 200 for processing nanoparticles using a self assembly mechanism, which is illustrated in more detail. This diagram is merely an example, which should not unduly limit the scope of the claims herein. One of ordinary skill in the art would recognize many variations, modifications, and alternatives. The system 200 has a substrate. Depending upon the specific embodiment, the substrate can be made of a suitable material including an insulating material, a conductive material, organic material, or a semiconductive material. The insulating material comprises a glass or ceramic material or quartz material. The conductive material can be almost any metal material, doped semiconductor material, or conductive polymer material according to a specific embodiment. The semiconductor material can include silicon, germanium, any Group III/V materials, or the like. The substrate can also be homogeneous, graded, or multilayered depending upon the embodiment. Of course, one of ordinary skill in the art would recognize many variations, modifications, and alternatives.

In a specific embodiment, the system also has various channels defined therein. A first channel region 201 disposed on a first portion of the substrate. The first channel region has a predetermined dimension including a first width and a first depth. The first channel region is configured to allow a first reactant species to flow there through. A second channel region is disposed on the second portion of substrate. The second channel region 203 has a predetermined dimension including a second width and a second depth. The second channel region is configured to allow a second reactant species to flow there through. A first orifice is coupled to an end of the first channel region, which is configured to output the first reactant species. A second orifice is coupled to an end of the second channel region, which is configured to output the second reactant species. A third channel region 205 is disposed on a third portion of the substrate. The third channel region has a first predetermined length and a second predetermined length.

In a preferred embodiment, the system has an interface region 207 along the first predetermined length in the third channel region, which is coupling the first orifice and to the second orifice at the interface region. One or more of the first reactant species is contacted with one or more of the second reactant species at the interface region to form a combined species of the one or more first reactant species and the one or more second reactant species. The combined species of the one or more first reactant and the one or more second reactant species is transferred from the first predetermined length to the second predetermined length of the third channel region. According to a specific embodiment, the interface region is also characterized by a predetermined shape, which maintains a laminar flow characteristic of any liquid in the interface region.

Depending upon the embodiment, the various channel regions can have certain predetermined characteristics. That is, the first channel has a width of about 50 microns and less and a depth of about 10 microns and less according to a specific embodiment. Additionally, the first channel, the second channel, and the third channel are provided on a substrate or within the substrate according to preferred embodiments. Of course, there can also be other variations, modifications, and alternatives.

Certain flow characteristics are also achieved according to embodiments of the present invention. In a specific embodiment, the first reactant species flow through the first channel region characterized by a laminar or like flow. The second reactant species flow through the second channel region characterized by a laminar or like flow. Preferably, the interface region is characterized by a laminar flow of the first reactant species and the second reactant species. Additionally, the interface region is substantially free from a mixing characteristic or other like characteristic.

According to a specific embodiment, the first and second reactive species can be selected according to certain desired results. The first reactant species are selected from organic molecules, biomolecules, polymers, metal nanoparticles, silica nanoparticles, or magnetic nanoparticles or any combination of these and the like. Similarly, the second reactant species are selected from organic molecules, biomolecules, polymers, metal nanoparticles, silica nanoparticles, or magnetic nanoparticles or any combination of these and the like. The combined species are formed using the first and second species and/or any other combination of species, including third, fourth, Nth, where N is an integer greater than four (4). In a specific embodiment, the combined species is covalently bonded. The combined species is a hybridized species of one or more of the first reactant species and the one or more of the second reactant species according to certain embodiments. The combined species is characterized by the laminar flow pattern and the predetermined length of the interface section in a third channel according to other embodiments.

A method for fabricating species of nanoparticles using the present self-assembly technique can be outlined as follows:

1. Flow a first reactant species through a first channel region, which has a predetermined dimension including a first width and a first depth;

2. Flow a second reactant species through a second channel region, which also has a predetermined dimension including a second width and a second depth;

3. Output the first reactant species through a first orifice exiting the first channel region;

4. Output the second reactant species through a second orifice exiting the second channel region;

5. Form an interface region along a first predetermined length in a third channel, which couples the first orifice to the second orifice at the interface region;

6. Contact one or more of the first reactant species with one or more of the second reactant species at the interface region to form a combined species of the one or more first reactant species and the one or more second reactant species;

7. Transfer the combined species of the one or more first reactant and the one or more second reactant species from the first predetermined length to a second predetermined length of the third channel region; and

8. Perform other steps, as desired.

The above sequence of steps provide a method of fabricating self-assembled structures according to an embodiment of the present invention. As shown, the method uses at least two reactant species in two respective channel regions combined at an interface region, which is characterized by laminar flow according to a specific embodiment. The interface region provides a site to form a combined species according to a specific embodiment. Additionally, certain steps may be combined, one or more steps may be added, and one or more steps may be removed, depending upon the embodiment. The sequence of the steps is changed in certain embodiments. Further details of the present methods and devices can be found throughout the present specification and more particularly below.

Various applications can be achieved using the present method and device. As merely an example, the combined species are provided in an high pressure liquid chromatography (HPLC) process according to a specific embodiment. A portion of the combined species is selectively deposited on a pre-determined portion of a substrate for deposition applications according to a specific embodiment. The combined species is selectively deposited using an energy coupled to the portion of the combined species according to other embodiments. The energy may be provided using electrodes, which are coupled to a voltage potential, inductive coil, or other driving source. Other applications may include, but are not limited to:

1. Chemical and biological sensors can be formed with appropriate molecular assembly on electrodes according to a specific embodiment.

2. Prosthetic devices are made with ordered molecular assembly according to alternative embodiments.

3. Molecular electronic devices are provided according to yet other embodiments.

4. Assembling nanoscale molecules to micro- and even meso-scale to enable useful device manufacture are included according to still other embodiments.

These and other applications can be found throughout the present specification as well as outside of the present specification. Of course, one of ordinary skill in the art would recognize many variations, modifications, and alternatives.

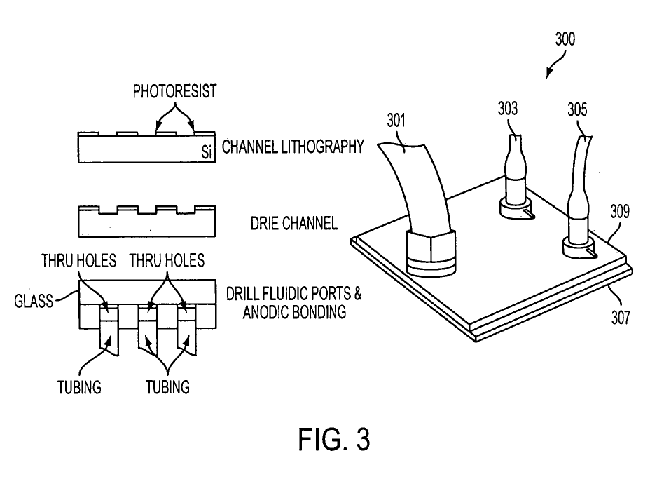

We have designed and fabricated various types of devices as described in the following. As merely an example, one of the devices uses PDMS molded channels bound to glass substrate, as illustrated by FIG. 3. This diagram is merely an example, which should not unduly limit the scope of the claims herein. One of ordinary skill in the art would recognize many variations, modifications, and alternatives. As shown, the device 300 has substrate 307 and overlying glass layer 309. In one embodiment, the substrate 307 is made of silicon. In another embodiment, the glass layer includes a polymer layer such as PDMS is a shorthand notation for polydimethylsiloxane, i.e., Me₃SiO(Me₂SiO)nSiMe₃, where Me=methyl groups and n varies from about 15 for small polymers with a viscosity of 10 centistokes, to about 1000 for large polymers of 100,000 centistoke viscosity. An example of PDMS is sold by a company called Dow Corning Corporation. The device also has a first input 303 and second input 305 and an output 301, which are coupled to the substrate. A simplified flow diagram for making the device is also illustrated by way of FIG. 3. The flow diagram includes providing a substrate, which is patterned using photolithography. An etching process is performed to form patterns on the substrate. A glass layer is bonded to the substrate, which is now fitted with tubes, e.g., plastic tubing. Of course, there can be other variations, modifications, and alternatives. Further details of a method for fabricating the self-assembly device can be found in more detail throughout the present specification and more particularly below.

According to a specific embodiment, a method for fabricating a self-assembly device can be described as follows.

1. Provide a first substrate, which has a surface region;

2. Form a first channel region, a second channel region, and a third channel region, including an interface region, in the first substrate;

3. Deposit a polymer layer overlying the surface region of the substrate to imprint the first channel region, the second channel region, and the third channel region thereon;

4. Clean a second substrate, including one or more electrode regions;

5. Couple the polymer layer including the imprint of the first channel region, the second channel region, and the third channel region onto the second substrate;

6. Provides the coupled polymer layer including the imprint of the first channel region, the second channel region, and the third channel region with the second substrate;

7. Use the coupled polymer layer and second substrate for a self-assembly or other like process; and

8. Perform other steps, as desired.

The above sequence of steps provide a method of fabricating a self-assembly device according to an embodiment of the present invention. As shown, the method uses at least two substrates, which are bonded together to form a fluidic self-assembly device. Additionally, certain steps may be combined, one or more steps may be added, and one or more steps may be removed, depending upon the embodiment. The sequence of the steps is changed in certain embodiments. Further details of the present methods and devices can be found throughout the present specification and more particularly below.

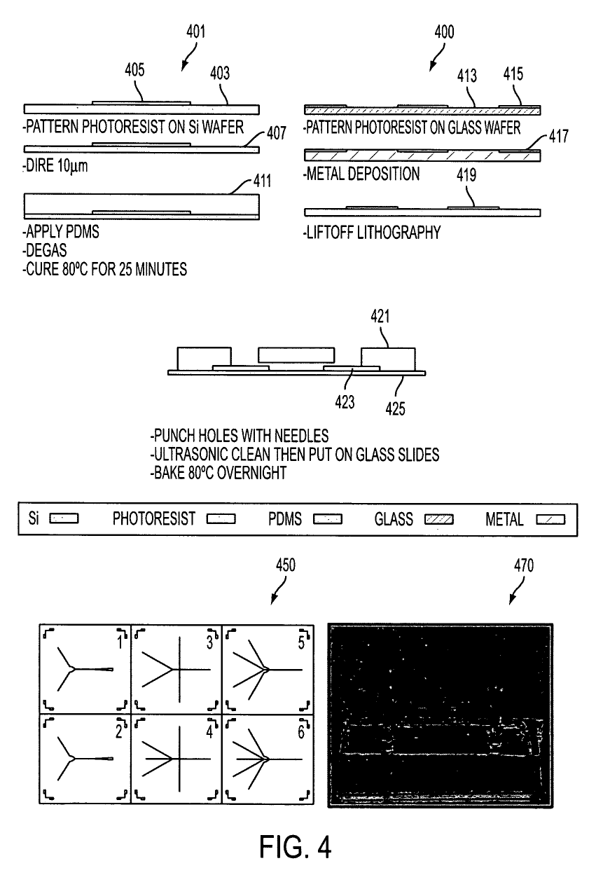

FIG. 4 is a simplified diagram of a process flow for fabricating a self-assembly system according to an embodiment of the present invention. This diagram is merely an example, which should not unduly limit the scope of the claims herein. One of ordinary skill in the art would recognize many variations, modifications, and alternatives. As shown, the present invention provides a method 400 for fabricating a self-assembly device. The method includes providing a first substrate 401, which has a surface region 403. The first substrate is made of a material such as silicon, glass, or others. The method includes forming a first channel region, a second channel region, and a third channel region, including an interface region 407, in the first substrate. The forming process often uses photolithographic 405 and etching techniques according to a specific embodiment.

In a specific embodiment, the method includes depositing a polymer layer 411 overlying the surface region of the substrate to imprint the first channel region, the second channel region, and the third channel region thereon. According to a specific embodiment, the polymer layer (or layers) can be any suitable material such as PDMS, Parylene, PMMA, and soda lime glass. In a specific embodiment, the substrate includes a polymer layer such as PDMS is a shorthand notation for polydimethylsiloxane, i.e., Me₃SiO(Me₂SiO)nSiMe₃, where Me=methyl groups and n varies from about 15 for small polymers with a viscosity of 10 centistokes, to about 1000 for large polymers of 100,000 centistoke viscosity. An example of PDMS is sold by a company called Dow Corning Corporation, but can be others. The polymer is often spun on, degassed, and cured for a selected period of time according to a specific embodiment.

In a specific embodiment, the method also includes providing a second substrate 413, which is often a glass layer or other suitable material. The method includes patterning a photoresist layer 415 onto the glass layer. Exposed regions 413 on the second substrate are also illustrated. The method includes depositing a metal layer 417 overlying the entirety of the substrate, including exposed regions and protected regions. The metal layer sticks to the exposed regions and lifts off of the protected regions, as illustrated by reference numeral 419. Depending upon the embodiment, there may also be other ways of forming the patterned metal layer, which will serve as interconnects, electrodes, and bonding pads, according to a specific embodiment.

The method includes coupling the polymer layer including the imprint of the first channel region, the second channel region, and the third channel region onto a second substrate. The coupling process often includes aligning the first and second substrates together and then bonding them together according to a specific embodiment. Before coupling, however, each of the surfaces of the substrates can be cleaned substantially using ultra-sonic cleaning techniques. The method provides the coupled polymer layer 421 including the imprint of the first channel region, the second channel region, and the third channel region with the second substrate 425. The second substrate also includes electrode regions 423, as shown. The method uses the coupled polymer layer and second substrate for a self-assembly or other like process, which has been described throughout the present specification and more particularly below.

Also shown in FIG. 4 are mask designs and a finished device. Micro-channels of 10 microns deep were molded onto PDMS surface, as also shown. Connections are made to the chip through punch holes. PDMS pieces are then bound to glass wafer, which has patterned Cr/Au electrodes. We have made a total of six designs (i.e., 1-6) 450 for this type of device with difference in number of input channels, channel widths and shear flow configurations. Because of the poor solvent compatibility of PDMS, we have designed and fabricated a glass/silicon device, as also shown. Fluidic channels are formed on silicon wafer with DIRE. Anodic bonding is used to bond silicon wafer to glass wafer. This device is able to handle any organic solvent including DCM and acetone that are not suitable for PDMS material. Of course, there can be other variations, modifications, and alternatives.

It is also understood that the examples and embodiments described herein are for illustrative purposes only and that various modifications or changes in light thereof will be suggested to persons skilled in the art and are to be included within the spirit and purview of this application and scope of the appended claims. As merely an example, reactants can be more than two and they can be fed into microfluidic device with different designs of mixing and shaping. In other embodiments, shear flow (e.g., for central flow confinement) may not be applied or applied. Alternatively, electrode design can adopt different geometries and with different materials in a variety of configurations. Depending upon the embodiment, electrodes can work as sensors to monitor the assembly process. Furthermore according to specific embodiments, collector design can adopt different geometries to facilitate different assembly reactions and provide other characteristics. Of course, there can be other variations, modifications, and alternatives. Further details of the present method and system can be found throughout the present specification and according to the experiments described below.

### EXPERIMENTS

To prove the principle and operation of the present invention, we performed various experiments. These experiments are merely examples, which should not unduly limit the scope of the claims herein. One of ordinary skill in the art would recognize many other variations, modifications, and alternatives. These examples have been provided below and are merely provided for illustration purposes only.

### Example 1

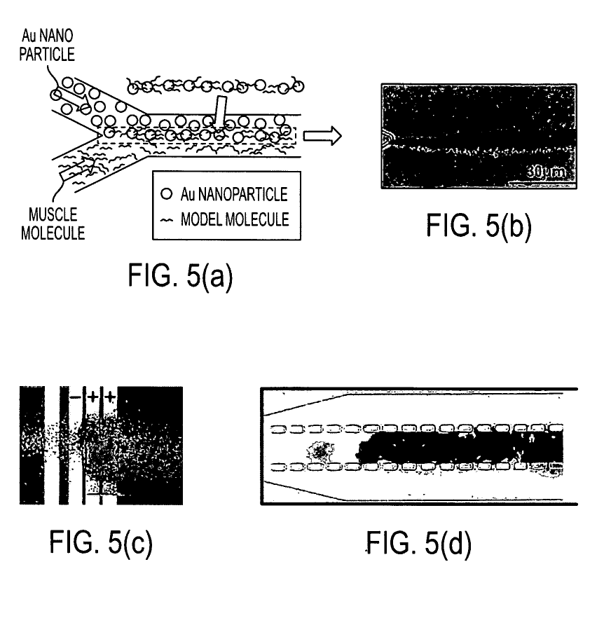

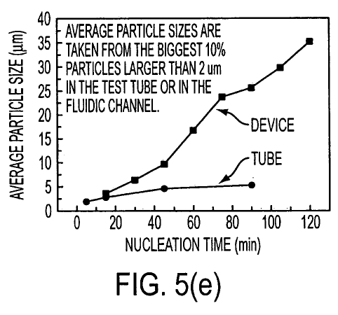

The present technology has been developed to manufacture micron-scale, muscle-like actuators from assemblies of nanoscale linear motor molecules and gold nanoparticles according to a specific embodiment. Integrated microfluidic systems are used to handle the sample preparation and to manipulate strategically etiolated motor molecules and gold nanoparticles. Our goal is to not only demonstrate the feasibility of fabricating biomimetic muscle fibers based upon engineered linear motor molecules, but to do so using scalable technology. As shown in FIGS. 5(a) and (b), nanoscale bidisulfide molecules and Au nanoparticles are assembled at flow interface. The assembly efficiency can be enhanced by electric field and selective growth of aggregate on/across electrodes can be achieved as shown in 5(c). Collector in the downstream is used to collect aggregate and achieve continuous growth of aggregate size with preferred geometry as shown in 5(d). A comparison of the aggregate growth rate in devices and in test tubes indicates assembly in devices is more efficient as shown in FIG. 5(e).

### Example 2

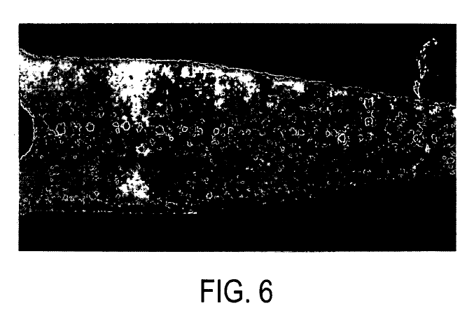

We demonstrated the feasibility of using “static” shear-flow interface for conjugation reaction which requires much longer reaction time according to a specific embodiment. In this case, a static liquid interface is built by gradually slowing down the input flow rate. FIG. 6 shows self-assembly of complementary gold/DNA conjugates through DNA hybridization at the liquid interface 12 hours after fluidic flows were stopped in shear flow channel. [See, J. J. Storhoff, A. A. Lazarides, R. C. Mucic, C. A. Mirkin, R. L. Letsinger and G. C. Schatz, J. Am. Chem. Soc. (2000), 122, 4640-4650.]

### Example 3

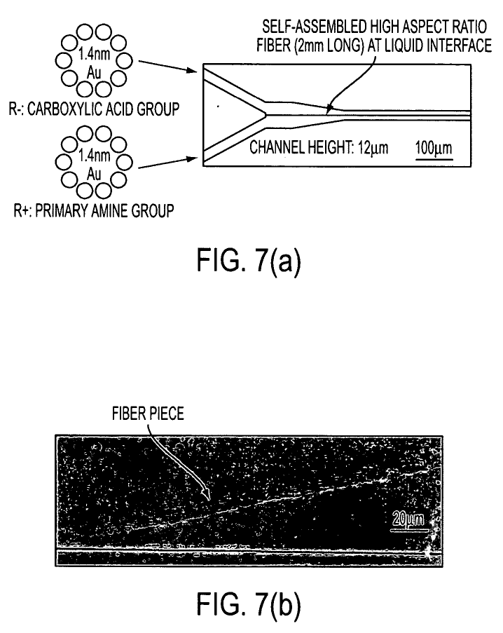

The third demonstration has been to assemble high-aspect-ratio fibers. To do so, separate positively and negatively charged gold nanoparticle streams are flown into the two-input shear flow device as shown in FIG. 7. FIG. 7(a) shows fiber/sheet structure formed along flow interface, and FIG. 7(b) shows assembled fiber piece flushed to the downstream. For example, electrostatic attraction between the positively and negatively charged gold nanoparticles quickly forms a 2 mm-long/12 μm-high fiber within seconds.

It is also understood that the examples and embodiments described herein are for illustrative purposes only and that various modifications or changes in light thereof will be suggested to persons skilled in the art and are to be included within the spirit and purview of this application and scope of the appended claims. As merely an example, the Parylene material has been deposited according to certain embodiments, other material can be injection molded such as thermoplastics and the like. Of course, there can be other variations, modifications, and alternatives.

What is claimed is:

1. A method for processing nanoparticles using a self assembly mechanism, the method comprising:
flowing a first reactant species through a first channel region, the first channel region having a predetermined dimension including a first width and a first depth;
flowing a second reactant species through a second channel region, the second channel region having a predetermined dimension including a second width and a second depth;
outputting the first reactant species through a first orifice exiting the first channel region;
outputting the second reactant species through a second orifice exiting the second channel region;
forming an interface region along a first predetermined length in a third channel, the third channel coupling the first orifice to the second orifice at the interface region;
contacting one or more of the first reactant species with one or more of the second reactant species at the interface region to form a combined species of the one or more first reactant species and the one or more second reactant species; and
transferring the combined species of the one or more first reactant and the one or more second reactant species from the first predetermined length to a second predetermined length of the third channel region.

2. The method of claim 1 wherein the first channel has a width of about 50 microns and a depth of about 10 microns.

3. The method of claim 1 wherein the combined species is covalently bonded.

4. The method of claim 1 wherein the combined species is a hybridized species of one or more of the first reactant species and the one or more of the second reactant species.

5. The method of claim 1 wherein the first channel, the second channel, and the third channel are provided on a substrate.

6. The method of claim 5 wherein the substrate comprises an insulating material, a conductive material, or a semiconductive material.

7. The method of claim 6 wherein the insulating material comprises a glass material.

8. The method of claim 1 wherein the first reactant species through the first channel region is characterized by a laminar flow.

9. The method of claim 1 wherein the second reactant species through the second channel region is characterized by a laminar flow.

10. The method of claim 1 wherein the interface region is characterized by a laminar flow of the first reactant species and the second reactant species.

11. The method of claim 1 wherein the interface region is substantially free from a mixing characteristic.

12. The method of claim 1 wherein the first reactant species are selected from organic molecules, biomolecules, polymers, metal nanoparticles, silica nanoparticles, or magnetic nanoparticles.

13. The method of claim 1 wherein the second reactant species are selected from organic molecules, biomolecules, polymers, metal nanoparticles, silica nanoparticles, or magnetic nanoparticles.

14. The method of claim 1 wherein the transferring of the combined species through the second predetermined length of the channel is characterized by a laminar flow.

15. The method of claim 1 wherein the combined species is characterized by a selected length of the combined species in the interface region.

16. The method of claim 1 wherein the interface region is subjected to an external energy source.

17. The method of claim 1 wherein the combined species are provided in an HPLC process.

18. The method of claim 1 wherein the interface region is characterized by a predetermined shape, the predetermined shape maintains a laminar flow characteristic in the interface region.

19. The method of claim 18 wherein the predetermined shape is provided in a cross-section of the interface region.

20. The method of claim 1 wherein the combined species has a flow velocity characterized by laminar flow through the interface region of the third channel.

21. The method of claim 1 wherein the combined species has a flow velocity associated with laminar flow through a cross-sectional area of the interface region.

22. The method of claim 1 wherein a portion of the combined species is selectively deposited on a pre-determined portion of a substrate.

23. The method of claim 22 wherein the combined species is selectively deposited using an energy coupled to the portion of the combined species.

24. The method of claim 1 wherein the combined species is provided for a sensing application.

25. A system for processing nanoparticles using a self assembly mechanism, the system comprising:
a substrate;
a first channel region disposed on a first portion of the substrate, the first channel region having a predetermined dimension including a first width and a first depth, the first channel region being configured to allow a first reactant species to flow there through;
a second channel region disposed on the second portion of substrate, the second channel region having a predetermined dimension including a second width and a second depth, the second channel region being configured to allow a second reactant species to flow there through;
a first orifice coupled to an end of the first channel region, the first orifice being configured to output the first reactant species;
a second orifice coupled to an end of the second channel region, the second orifice being configured to output the second reactant species;
a third channel region disposed on a third portion of the substrate, the third channel region having a first predetermined length and a second predetermined length;
an interface region along the first predetermined length in the third channel region, the third channel region coupling the first orifice to the second orifice at the interface region;
whereupon one or more of the first reactant species is contacted with one or more of the second reactant species at the interface region to form a combined species of the one or more first reactant species and the one or more second reactant species; and
whereupon the combined species of the one or more first reactant and the one or more second reactant species is transferred from the first predetermined length to the second predetermined length of the third channel region.

26. The system of claim 25 wherein the first channel has a width of about 50 microns and a depth of about 10 microns.

27. The system of claim 25 wherein the combined species is covalently bonded.

28. The system of claim 25 wherein the combined species is a hybridized species of one or more of the first reactant species and the one or more of the second reactant species.

29. The system of claim 25 wherein the first channel, the second channel, and the third channel are provided overlying the substrate.

30. The system of claim 29 wherein the substrate comprises an insulating material, a conductive material, or a semiconductive material.

31. The system of claim 30 wherein the insulating material comprises a glass material.

32. The system of claim 25 wherein the first channel region is characterized to provide a laminar flow of the first reactant species.

33. The system of claim 25 wherein the second channel region is characterized to provide a laminar flow of the second reactant species.

34. The system of claim 25 wherein the interface region is characterized to provide a laminar flow of the first reactant species and the second reactant species.

35. The system of claim 25 wherein the interface region is substantially free from a mixing characteristic of the first reactant species and the second reactant species and/or the combined species.

36. The system of claim 25 wherein the first reactant species are selected from organic molecules, biomolecules, polymers, metal nanoparticles, silica nanoparticles, or magnetic nanoparticles.

37. The system of claim 25 wherein the second reactant species are selected from organic molecules, biomolecules, polymers, metal nanoparticles, silica nanoparticles, or magnetic nanoparticles.

38. The system of claim 25 wherein the second predetermined length of the channel is characterized to provide a laminar flow of the combined species.

39. The system of claim 25 wherein the combined species is characterized by a selected length of the combined species in the interface region.

40. The system of claim 25 wherein the interface region is coupled to an external energy source.

41. The system of claim 25 wherein the third channel region is coupled to an HPLC process and the combined species are provided to the HPLC process.

42. The system of claim 25 wherein the interface region is characterized by a predetermined shape, the predetermined shape maintains a laminar flow characteristic in the interface region.

43. The system of claim 42 wherein the predetermined shape is provided in a cross-section of the interface region.

44. The system of claim 25 wherein the combined species has a flow velocity characterized by laminar flow through the interface region of the third channel.

45. The system of claim 25 wherein the combined species has a flow velocity associated with laminar flow through a cross-sectional area of the interface region.

46. The method of claim 25 wherein a portion of the combined species is selectively deposited on a pre-determined portion of a substrate.

47. The method of claim 46 wherein the combined species is selectively deposited using an energy coupled to the portion of the combined species.

48. The method of claim 25 wherein the combined species is provided for a sensing application.

49. A method for fabricating a self-assembly device comprising:
providing a first substrate, the first substrate comprising a surface region;
forming a first channel region, a second channel region, and a third channel region, including an interface region, in the first substrate;
depositing a polymer layer overlying the surface region of the substrate to imprint the first channel region, the second channel region, and the third channel region thereon;
coupling the polymer layer including the imprint of the first channel region, the second channel region, and the third channel region onto a second substrate;
providing the coupled polymer layer including the imprint of the first channel region, the second channel region, and the third channel region with the second substrate; and
using the coupled polymer layer and second substrate for a self-assembly process.

50. The method of claim 49 wherein the first substrate is a silicon wafer.

51. The method of claim 49 wherein the second substrate is a glass substrate.

52. The method of claim 49 wherein the polymer layer comprises PDMS.

53. The method of claim 49 wherein the forming comprises reactive ion etching.

54. The method of claim 49 further comprising cleaning the second substrate before the coupling step.

55. The method of claim 54 wherein the cleaning comprises ultra-sonic treatment of the second substrate.

56. The method of claim 49 further comprises degassing the polymer layer after depositing the polymer layer on the surface region.

57. The method of claim 49 further comprising forming one or more electrode regions on the second substrate, the one or more electrode regions electrically coupling to one of the first channel region, second channel region, or third channel region.

58. The method of claim 49 further comprising forming one or more bonding pad regions coupled to the one or more electrode regions.
